(19) United States
(12) Patent Application Publication
(10) Pub. No.: US 2010/0296629 A1
(43) Pub. Date: Nov. 25, 2010

(54) GRADED LENSES

(75) Inventor: Sultan B. Dabagov, Frascati (IT)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: UNISANTIS FZE, Jebel Ali, Dubai (AE)

(21) Appl. No.: 12/743,502

(22) PCT Filed: Dec. 9, 2008
(86) PCT No.: PCT/EP08/10440

§ 371 Date: Aug. 4, 2010

(30) Foreign Application Priority Data
Dec. 10, 2007 (EP) 07023890.2

(51) Int. Cl. G21K 1/06; G21K 1/00

(52) U.S. Cl. 378/85; 250/505.1

(57) ABSTRACT

A waveguide apparatus comprising a bundle of polycapillaries and a longitudinal axis is described. Each polycapillary comprises a plurality of capillary channels, wherein the diameter of the polycapillaries and/or of the capillary channels is changing (e.g., increasing or decreasing) across a cross section of the waveguide apparatus perpendicular to the longitudinal axis.

### TECHNICAL FIELD

This invention relates to the field of electromagnetic energy waveguides and more specifically, but not exclusively, to such waveguides utilised as x-ray lenses and comprising glass polycapillaries and channels of varying diameters across their cross-section.

### BACKGROUND

Waveguides such as lenses or collimators comprising glass tubes, capillaries, polycapillaries and channels to guide and focus electromagnetic energy including x-rays are known in the art, and are generally referred to as polycapillary lenses. Such lenses typically comprise a plurality of hollow glass capillaries of similar cross sectional diameter which are heated and drawn together to form a collimating waveguide (a monolithic lens) typically used in x-ray analytical equipment for the production of parallel x-ray beams or for focused x-ray beams, respectively.

Typical polycapillary lenses of the type described above comprise capillaries which have similar individual cross sectional diameter dimensions across each end (i.e. input end and exit end), however it is sometime the case that due to the choice of the length of such lenses, the actual diameter of the input and output ends of the lenses and the associated polycapillaries differ slightly, but not by orders or magnitude (i.e. input end diameter 4 mm and output end diameter 4.5 mm).

Accordingly, the corresponding diameter of each end of the ends of the polycapillary tubes comprising a lens or waveguide in a state of the art polycapillary lens or waveguide is in the same order (i.e. 2-10 microns).

The physical principles of critical angle based total external reflection providing for the capture, transmission and exit of electromagnetic radiation (including x-rays) from a source, through a polycapillary lens, to the output end are well known in the art. However, will be understood by those in the art that the physical transmission and associated output characteristics of such lenses differ from the centre of such a lens to its periphery in so far that typically the transmission of x-rays through the centre of such lens and waveguide assemblies is greater at the centre, and decreases towards the periphery.

The invention described herein provides a solution to the long existing problem of the reduction in the capture properties at the input (capture) end of a lens of waveguide, and the transmission properties along such lenses and waveguides specifically in relation to the location from the centre line of such lenses and waveguides.

### SUMMARY OF THE INVENTION

Accordingly there is provided a waveguide apparatus for the capture, transmission through and output of electromagnetic radiation, said apparatus consisting of a monolithic structure comprising of a plurality of polycapillary means, each of said polycapillary means further containing a plurality of capillary channel means and having an input end, a length and an output end, wherein the diameters of the plurality of polycapillary means and respective channel means at the input and output and ends, and along the said length, varies or changes across the cross section of said waveguide apparatus.

The diameters may change (e.g., increase or decrease) in an essentially monotonous manner. Essentially means here, that due to manufacturing tolerances and similar technical constraints deviations from a strict monotony may occur. The changes may be essentially continuous (which could, for example, mean that polycapillaries neighbouring in the radial direction seen from the centre of the lens will generally have different diameters) or step wise (which means that two, three or more radially extending zones of polycapillaries with different diameters exist). In the case of step wise changes, three to ten or more steps may be realized.

The waveguide apparatus as described above may comprise glass polycapillaries.

The waveguide apparatus as described above may operate as electromagnetic radiation focusing lens or to produce a beam of substantially parallel electromagnetic radiation output.

In the waveguide apparatus as described above, said diameters of tube means may be greatest near to the central longitudinal axis of said waveguide apparatus, and may decrease towards the periphery.

In the waveguide apparatus as described above, said diameters of tube means may alternatively be the least near to the central longitudinal axis of said waveguide apparatus, and may increase towards the periphery.

### BRIEF DESCRIPTION OF DRAWINGS

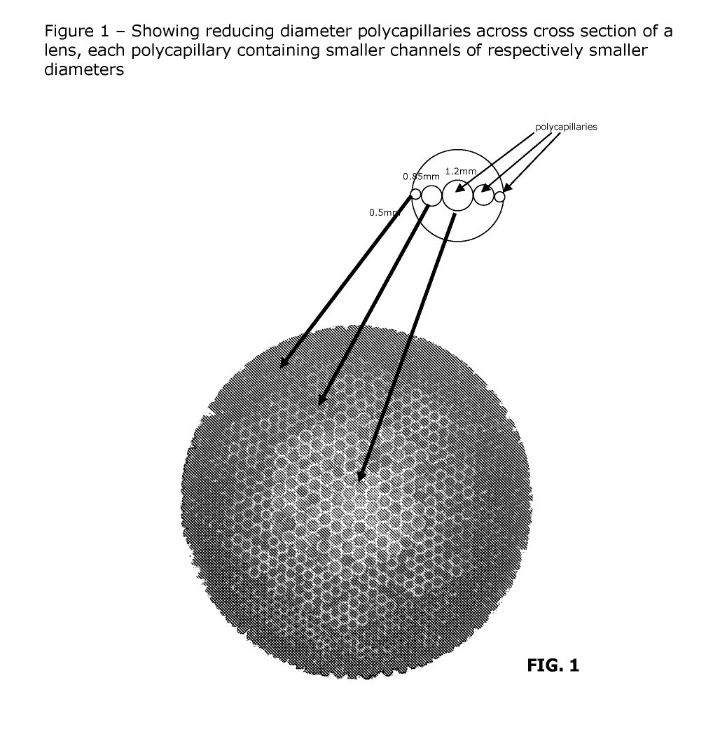

The invention will be described herein by way of example only with reference to the accompanying diagram in which single FIG. 1 is a diagrammatic representation of an input or output end of a lens in accordance with the invention.

### DETAILED DESCRIPTION OF THE INVENTION AND PREFERRED EMBODIMENTS

In a preferred embodiment of the invention and in a surprising departure from the known art in the field, a waveguide apparatus referred to as a ‘Graded Lens’ in the form of an x-ray focusing lens is constructed by first simultaneously heating and drawing a plurality of glass tubes held in a substantially circular bundle form and encased in an outer glass tube to form a series of ‘polycapillaries’, each of which is essentially a tube containing a plurality of smaller glass tubes known as channels. By way of further explanation and example, each polycapillary may be in the order of 1 mm to 0.6 mm and may contain a plurality of ‘channels’ of relative diameters 10 microns to 5 microns, respectively.

Where the lens is so designed to taper to form both input and output ends (e.g. in the manner of a barrel or half-barrel), the diameters of the channels contained within the respective polycapillaries will therefore reduce and may be reduced from 10 to 6 microns to the order of 6 to 3 microns respectively.

To construct a waveguide apparatus in the form of a lens, a plurality of polycapillaries each containing channels are held in a bundle and typically encased by an outer tube means, and the whole assembly of polycapillaries and outer tube means is heated and extruded (or drawn) so as to form an elongated and reduced diameter form. Depending on the extent of extrusion (or drawing), polycapillaries of different diameters can be formed, and the individual capillaries included in each polycapillary will likewise have different diameters. In the present example, it will be assumed that three different types of polycapillaries with three different polycapillary diameters (and, accordingly, three different diameters of the individual capillaries) will be provided. It will be apparent to the skilled artisan that more (e.g. 5 or 10 ) or less polycapillary types with different diameters can be provided.

The individual polycapillaries of one of three different diameters containing their respective diameter channels are positioned with the largest diameter polycapillaries being positioned closest to the central longitudinal axis of the bundle, and the two remaining diameter polycapillaries being placed concentrically around said longitudinal axis, the smaller diameter capillaries being positioned to the outermost concentric positions such that a loose assembly is obtained.

The action of heating and drawing the assembly of polycapillaries and associated channels produces an extrusion of fused, monolithic glass capillaries which forms a waveguide means in accordance with the invention. Numerous waveguides may be produced from a single drawing action, and the particular shape and form characteristics required for a waveguide to act as a focusing lens or alternatively as a means to produce parallel beams of radiation are determined by the acceleration and deceleration of the drawing process, and the positions at which section of the drawn length of the bundle is cut.

FIG. 1 is a diagrammatic representation of the end view of an input or output end of a waveguide in the form of a lens in accordance with the invention showing the relative differences in diameter of the glass polycapillaries across the diameter of said lens and illustrating the position of same on a photograph of a Graded Lens.

Graded lenses are accordingly designed for maximum utilisation of the channels lying away from the centre longitudinal axis having consideration for the critical angle condition required for electromagnetic radiation such as x-ray to enter such a channel and exhibit transmission along its length via the mechanism of total external reflection.

Graded lenses in accordance with the invention may also be utilised to focus transmitted particles at different energies at different focal positions and accordingly can be used by way of x-ray spectrometers and the like to by focusing a fluorescent x-ray beam from an irradiated sample onto different focal positions as per the characteristic energy of various elements. By moving a detector means on relation to the output of such a graded lens, the elemental concentrations in any sample may be accordingly measured and determined.

The invention as described herein provides for significantly increased transmission of electromagnetic source energy such as x-rays through such lenses and provides for the more effective transmission of high energy x-ray through such polycapillary based lenses.

1. A waveguide apparatus comprising a bundle of polycapillaries and a longitudinal axis, each polycapillary comprising a plurality of capillary channels, wherein the diameter of the polycapillaries and/or of the capillary channels is essentially decreasing from a centre of the waveguide apparatus towards its periphery across a cross section of the waveguide apparatus, the cross section being taken perpendicular to the longitudinal axis.

2. The waveguide apparatus of claim 1, wherein the diameter is changing essentially monotonically.

3. The waveguide apparatus of claim 1, wherein the diameter is decreasing essentially in a plurality of steps.

4. The waveguide apparatus of claim 3, wherein the diameter is decreasing in three to ten steps.

5. The waveguide apparatus of claim 1 or 2, wherein the diameter is decreasing essentially continuously.

6. The waveguide apparatus of claim 1, wherein the diameter of both the polycapillaries and the capillary channels is changing in a proportional manner.

7. The waveguide apparatus of claim 1, wherein the bundle of polycapillaries forms a monolithic structure.

8. The waveguide apparatus of claim 1, wherein the apparatus has the outer form of a barrel or of a half barrel.

9. An x-ray spectrometer comprising the waveguide apparatus of claim 1 and an x-ray detector.

10. (canceled)
